(19) United States
(12) Patent Application Publication
(10) Pub. No.: US 2009/0237341 A1
(43) Pub. Date: Sep. 24, 2009

(54) Gate driving module and LCD thereof

(76) Inventors: Yung-Chih Chen, Hsin-Chu (TW); Chih-Yuan Chien, Hsin-Chu (TW); Po-Yuan Liu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/110,343

(22) Filed: Apr. 27, 2008

(30) Foreign Application Priority Data
Mar. 20, 2008 (TW) 097109840

(51) Int. Cl. G09G 3/36

(52) U.S. Cl. 345/92; 345/90

(57) ABSTRACT

A gate driving module drives a display device having a plurality of first switch units. The gate driving module includes a gate driving circuit, a switch controlling circuit, and a plurality of switch sets. The gate driving circuit includes a plurality of first output ends for outputting a plurality of gate driving signals. The switch controlling circuit includes a plurality of second output ends for outputting a plurality of switch controlling signals. Each switch set includes at least two second switch units. One end of each second switch unit is coupled to a corresponding first output end of the gate driving circuit, the other end of each second switch unit is coupled to the control end of a corresponding first switch unit, and the control end of each second switch unit is coupled to a corresponding second output end.

### BACKGROUND OF THE INVENTION

1. Field of the Invention

The present invention relates to a gate driving module, and more particularly, to a gate driving module which saves number of gate driving circuits by employing a switching method.

2. Description of the Prior Art

Please refer to FIG. 1. FIG. 1 is a diagram illustrating a conventional Liquid Crystal Display (LCD) 100. As shown in FIG. 1, the LCD 100 comprises a gate driving circuit 110, a data driving circuit 120, and a pixel area 130. The gate driving circuit 110 comprising M gate lines outputs M gate driving signals sequentially. The data driving circuit 120 comprising Q data lines outputs Q data signals. The pixel area 130 is constructed by the M gate driving lines of the gate driving circuit 110 and the Q data lines of the data driving circuit 120. Thus, the pixel area 130 comprises Q(column)×M(row) pixels. That is, the resolution of the LCD 100 is Q×M.

Please refer to FIG. 2. FIG. 2 is a diagram illustrating another conventional LCD 200. As shown in FIG. 2, the LCD 200 comprises gate driving circuits 211 and 212, a data driving circuit 220, and a pixel area 230. The gate driving circuit 211 comprising M gate lines outputs M gate driving signals sequentially. The gate driving circuit 212 comprising M gate lines outputs M gate driving signals sequentially. The data driving circuit 220 comprising Q data lines outputs Q data signal. The pixel area 230 is constructed by the two M gate driving lines of the gate driving circuits 211 and 212 and the Q data lines of the data driving circuit 220. Thus, the pixel area 230 comprises Q(column)×2M(row) pixels. That is, the resolution of the LCD 200 is Q×2M. It is shown that both the number of the gate lines and the amount of gate drive circuit are increase as the resolution of an LCD increases. Therefore, the price of the LCD would increase, when the resolution of the LCD is multiplied.

### SUMMARY OF THE INVENTION

The present invention provides a gate driving module for driving a display device. The display device has a plurality of first switch units. The gate driving module comprises a gate driving circuit, a switch controlling circuit, and a plurality of switch sets. The gate driving circuit comprises a plurality of first output ends for outputting a plurality of gate driving signals. The switch controlling circuit comprises a plurality of second output ends for outputting a plurality of switch controlling signals. Each of the plurality of the switch sets comprises at least two second switch units. One end of the each second switch unit is coupled to a corresponding first output end of the plurality of the first output ends of the gate driving circuit. Another end of the each second switch unit is coupled to a control end of a corresponding first switch unit of the plurality of the first switch units of the display device. A control end of each second switch unit is coupled to a corresponding second output end of the plurality of the second output end of the switch controlling circuit. Wherein the number of the first switch units of the display device is a multiple number of the first output ends of the gate driving circuit.

The present invention further provides an LCD. The LCD comprises a plurality of first switch units, a gate driving module, a plurality of switch sets, and a data driving circuit. The gate driving module comprises a gate driving circuit and a switch controlling circuit. The gate driving circuit comprises a plurality of first output ends for outputting a plurality of gate driving signals. The switch controlling circuit comprises a plurality of second output ends for outputting a plurality of switch controlling signals. Each of the plurality of the switch sets comprises at least two second switch units. One end of the each second switch unit is coupled to a corresponding first output end of the plurality of the first output ends of the gate driving circuit. Another end of the each second switch unit is coupled to a control end of a corresponding first switch unit of the plurality of the first switch units. A control end of the each second switch unit is coupled to a corresponding second output end of the switch controlling circuit. The data driving circuit comprises a plurality of third output ends. Each third output end is corresponding coupled to the input end of the first switch for transmitting corresponding data. Wherein number of the first switch units of the display device is a multiple number of the first output ends of the gate driving circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional LCD.

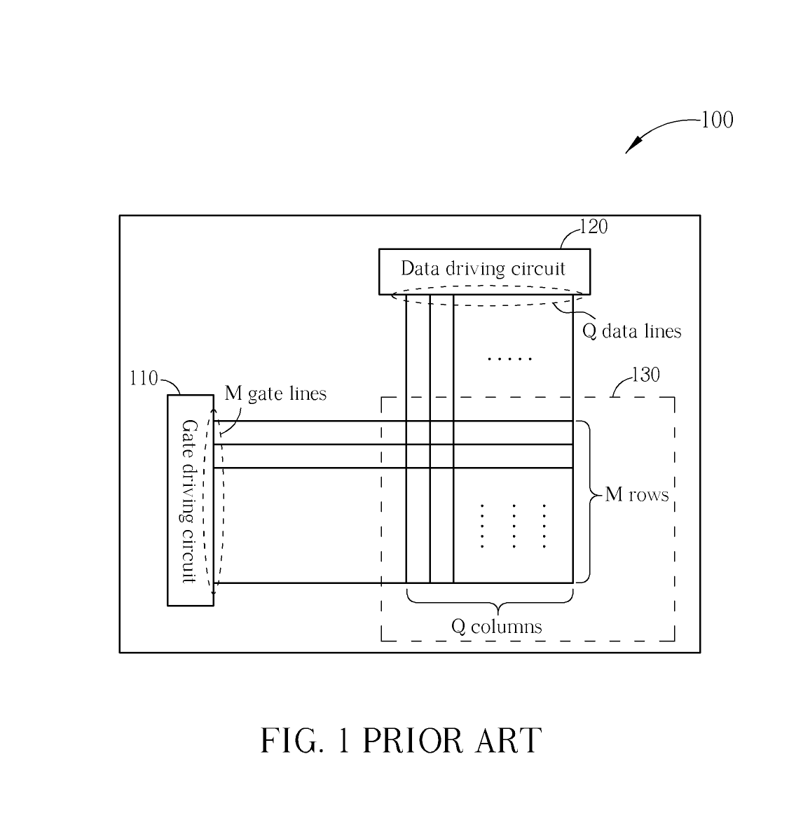

FIG. 2 is a diagram illustrating another conventional LCD with higher resolution.

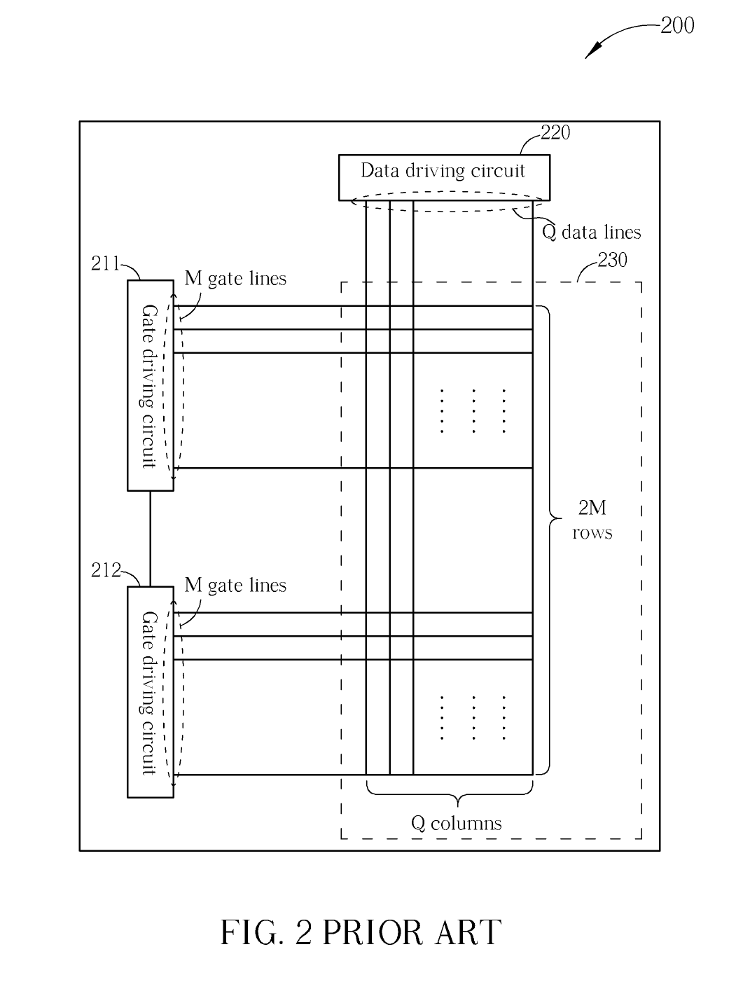

FIG. 3 is an LCD according to a first embodiment of the present invention.

FIG. 4 is a timing diagram illustrating the relation between the switch controlling signal and the gate driving signal.

FIG. 5 is a diagram illustrating an LCD according to a second embodiment of the present invention.

### DETAILED DESCRIPTION

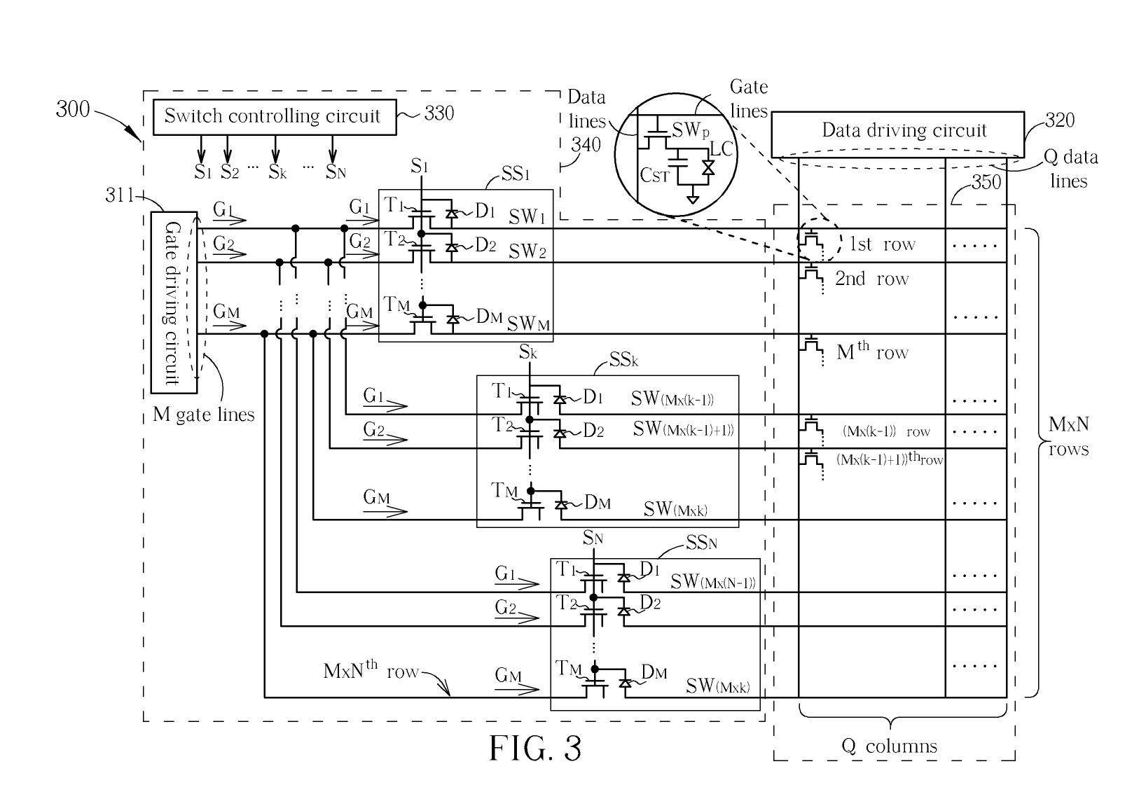

Please refer to FIG. 3. FIG. 3 is an LCD 300 according to a first embodiment of the present invention. As shown in FIG. 3, the LCD 300 comprises a gate driving module 340, a data driving circuit 320, and a pixel area 350. The data driving circuit 320 comprising Q data lines (output ends) outputs Q data signals respectively. The pixel area 350 is constructed by Q(column)×(M×N)(row) pixels. That is, the highest resolution of the LCD 300 is Q×M×N. Each pixel of the pixel area 350 comprises a first switch unit SW_{P}, a storing capacitor C_{ST}, and a corresponding liquid crystal layer area LC. The first switch unit SW_{P} comprises a first end, a second end, and a control end. The first end of the first switch unit SW_{P} coupled to a corresponding data line of the data driving circuit 320 receives corresponding data signal. The second end of the first switch unit SW_{P} is coupled to the storing capacitor C_{ST} and the corresponding liquid crystal layer area LC. The control end of the first switch unit SW_{P} coupled to a corresponding gate line of the gate driving module 340 receives a corresponding gate driving signal. When the control end of the first switch unit SW_{P} receives the corresponding gate driving signal, the data signal of the corresponding data line is transmitted through the first switch unit to the storing capacitor C_{ST} and the corresponding liquid crystal layer area LC and thereby the LCD 300 displays an image. Thus, as shown in FIG. 3, when the number of the columns of the pixels of the pixel area 350 is M×N, (M×N) gate driving signals are required to display an image. In this embodiment, M, N, and Q are all integers.

The gate driving module 340 comprises a gate driving circuit 311, a switch controlling circuit 330, and N switch sets SS₁˜SS_{N}. The gate driving circuit 311 comprising M gate lines (output ends) outputs M gate driving signals G₁˜G_{M} sequentially. The switch controlling unit 330 comprising N output ends outputs N switch controlling signals S₁˜S_{N} sequentially. Each switch set of the switch sets SS₁˜SS_{N} comprises M second switch units (for example, SW₁, SW₂, SW_{M} . . . SW_{(M×(K-1))}, SW_{(M×(K-1)+1)} . . . SW_{(M×(N-1))} . . . SW_{(M×N)}). Each second switch unit comprises a first end, a second end, and a control end. The second switch unit can be realized with a Thin Film Transistor (TFT) and a diode. For example, the second switch unit SW₁ comprises a TFT T₁ and a diode D₁. The positive end of the diode D₁ is coupled to the second end of the TFT T₁, the negative end of the diode D₁ is coupled to the control end of the second switch unit SW₁. The diode D₁ can be realized with a TFT, a Metal Oxide Semiconductor (MOS) transistor, or a Bipolar Junction Transistor (BJT) as desired. In this embodiment, the control end (gate) of the TFT is the control end of the second switch unit. The first end of the TFT is the first end of the second switch unit. The second end of the TFT is the second end of the second switch unit.

In the switch set SS₁, the control end of each second switch unit coupled to the first output end of the switch controlling circuit receives the switch controlling signal S₁; the first end of the second switch unit SW₁ is coupled to the first output end of the gate driving circuit 311; the second end of the second switch unit SW₁ is coupled to the first gate line of the pixel area 350; the first end of the second switch unit SW₂ is coupled to the second output end of the gate driving circuit 311; the second end of the second switch unit SW₂ is coupled to the second gate line of the pixel area 350; . . . ; the first end of the second switch unit SW_{M} is coupled to the M^{th} output end of the gate driving circuit 311; the second end of the second switch unit SW_{M} is coupled to the M^{th} gate line of the pixel area 350.

In the switch set SS₂ (not shown), the control end of each second switch unit coupled to the second output end of the switch controlling circuit receives the switch controlling signal S₂; the first end of the second switch unit SW_{(M+1)} is coupled to the first output end of the gate driving circuit 311; the second end of the second switch unit SW_{(M+1)} is coupled to the (M+1)^{th} gate line of the pixel area 350; the first end of the second switch unit SW_{(M+2)} is coupled to the second output end of the gate driving circuit 311; the second end of the second switch unit SW_{(M+2)} is coupled to the (M+2)^{th} gate line of the pixel area 350; . . . ; the first end of the second switch unit SW_{2M} is coupled to the M^{th} output end of the gate driving circuit 311; the second end of the second switch unit SW_{2M} is coupled to the 2M^{th} gate line of the pixel area 350.

In the switch set SS_{K}, the control end of each second switch unit coupled to the K^{th} output end of the switch controlling circuit receives the switch controlling signal S_{K}; the first end of the second switch unit SW_{(M×(K-1))} is coupled to the first output end of the gate driving circuit 311; the second end of the second switch unit SW_{(M×(K-1))} is coupled to the (M×(K−1))^{th} gate line of the pixel area 350; the first end of the second switch unit SW_{(M×(K-1)+1)} is coupled to the second output end of the gate driving circuit 311; the second end of the second switch unit SW_{(M×(K-1)+1)} is coupled to the (M×(K−1)+1)^{th} gate line of the pixel area 350; . . . ; the first end of the second switch unit SW_{M×K} is coupled to the M^{th} output end of the gate driving circuit 311; the second end of the second switch unit SW_{M×K} is coupled to the (M×K)^{th} gate line of the pixel area 350.

In the switch set SS_{N}, the control end of each second switch unit coupled to the N^{th} output end of the switch controlling circuit receives the switch controlling signal S_{N}; the first end of the second switch unit SW_{(M×(N-1))} is coupled to the first output end of the gate driving circuit 311; the second end of the second switch unit SW_{(M×(N-1))} is coupled to the (M×(N−1))^{th} gate line of the pixel area 350; the first end of the second switch unit SW_{(M×(N-1)+1)} is coupled to the second output end of the gate driving circuit 311; the second end of the second switch unit SW_{(M×(N-1)+1)} is coupled to the (M×(N−1)+1)^{th} gate line of the pixel area 350; . . . ; the first end of the second switch unit SW_{M×N} is coupled to the M^{th} output end of the gate driving circuit 311; the second end of the second switch unit SW_{M×N} is coupled to the (M×N)^{th} gate line of the pixel area 350.

According to the description above, the rules for coupling of the second switch units are described as follows: The first end of the Y^{th} second switch unit of the X^{th} switch set coupled to the Y^{th} output end of the gate driving circuit 310 receives the gate driving signal G_{Y}, the control end of the Y^{th} second switch unit of the X^{th} switch set coupled to the X^{th} output end of the switch controlling circuit 330 receives the switch controlling signal S_{X}, and the second end of the Y^{th} second switch unit of the X^{th} switch set is coupled to the (X×Y)^{th} gate line (namely, coupled to the control end of the first switch unit corresponding to the (X×Y)^{th} gate line.)

In this way, the gate driving module 340 merely utilizes a gate driving circuit 330, instead of N gate driving circuits to drive an M×N column pixel area 350. The gate driving module 340 can switch the gate driving circuit 311 to output the gate driving signals G₁˜G_{M} sequentially for driving the (M×N) columns pixel area 350 by the gate driving circuit 330 and a plurality of switch sets SS₁˜SS_{N}.

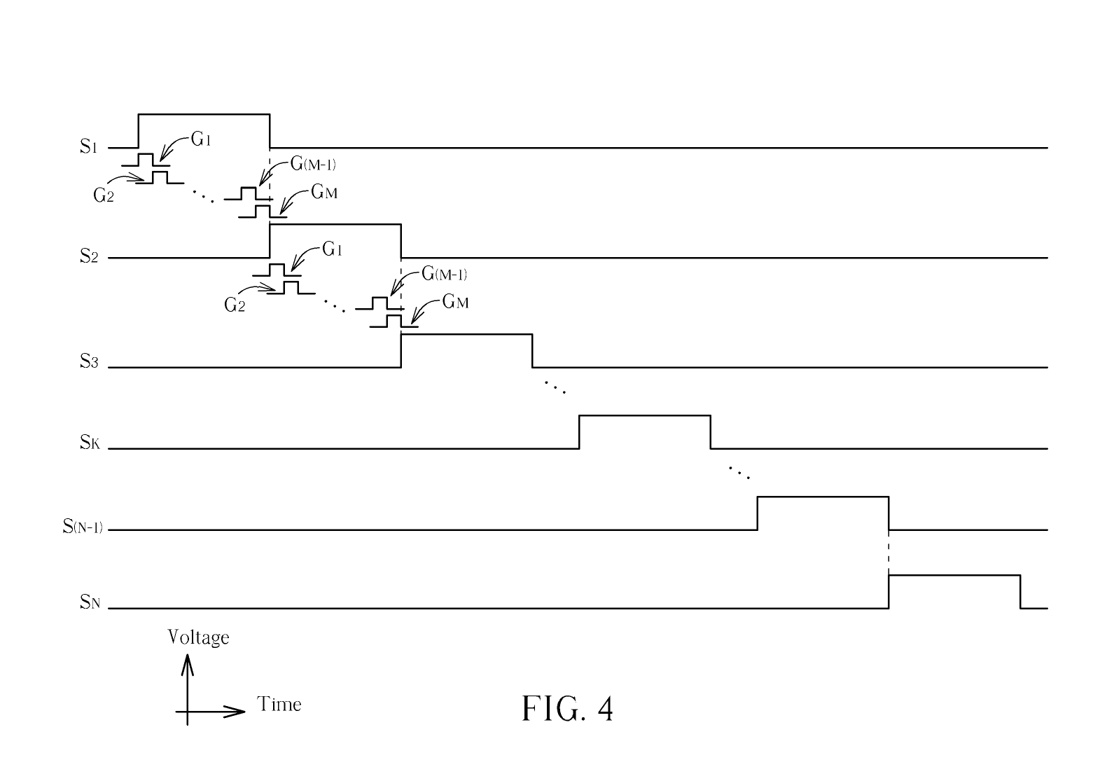

Please refer to FIG. 4. FIG. 4 is a timing diagram illustrating the relation between the switch controlling signal and the gate driving signal. As shown in FIG. 4, the switch controlling signals S₁˜S_{N} are generated sequentially. The period of a switch controlling signal is the sum of the periods of the M gate driving signals. More particularly, when the gate driving circuit 311 executes the first scanning to sequentially transmit the gate driving signals G₁˜G_{M}, the switch controlling circuit 330 generates the switch controlling signal S₁ during the entire period for the first scanning. After the first scanning is done, the gate driving circuit 311 executes the second scanning to sequentially transmit the gate driving signals G₁˜G_{M}, the switch controlling circuit 330 generates the switch controlling signal S₂ during the entire period for the second scanning. After the (K−1)^{th} scanning is done, the gate driving circuit 311 executes the K^{th} scanning to sequentially transmit the gate driving signals G₁˜G_{M}, the switch controlling circuit 330 generates the switch controlling signal S_{K} during the entire period for the K^{th} scanning, and so on. In this way, the first to the Mₜₕ gate lines are driven by the gate driving signals G₁˜G_{M} (when the gate driving circuit 311 executes the first scanning) and the switch set SS₁, the (M+1)^{th} to the (2M)^{th} gate lines are driven by the gate driving signal G₁˜G_{M} (when the gate driving circuit 311 executes the second scanning) and the switch set SS₂ . . . the [M×(K−1)]^{th} to the (M×K)^{th} gate lines are driven by the gate driving signal G₁˜G_{M} (when the gate driving circuit 311 executes the K^{th} scanning) and the switch set SS_{K} . . . the [M×(N−1)]^{th} to the (M×N)^{th} gate lines are driven by the gate driving signal G₁˜G_{M} (when the gate driving circuit 311 executes the N^{th} scanning) and the switch set SS_{N}. Consequently, the LCD 300 can display a frame with the resolution of (M×N×Q) with only one gate driving circuit.

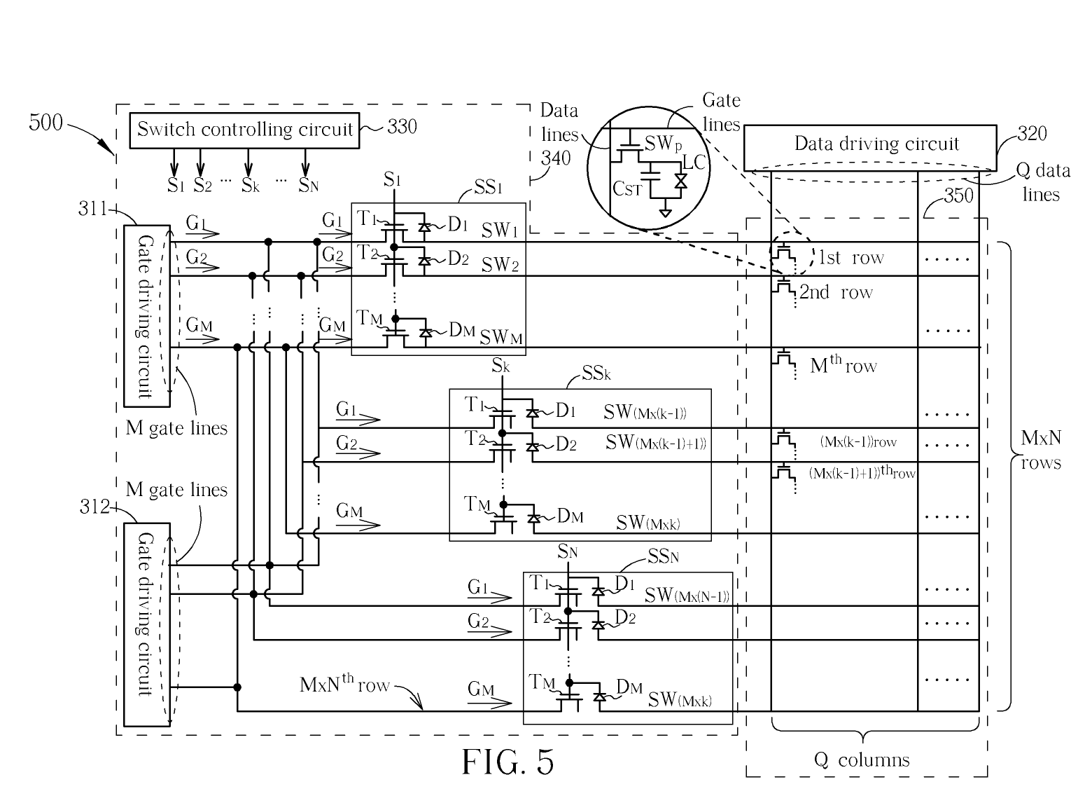

Please refer to FIG. 5. FIG. 5 is a diagram illustrating an LCD 500 according to a second embodiment of the present invention. The LCD 500 is similar to the LCD 300. The only difference between the LCDs 500 and 300 is that an additional gate driving circuit 312 is added in the LCD 500. The gate driving circuits 311 and 312 can be respectively disposed in the different areas of the LCD 500, e.g. upper part of the LCD 500 and the lower part of the LCD 500. The deployment of the gate driving circuit 311 and 312 reduces the degeneration and the delay of the gate driving signals caused by the lengths of the driving paths. In this way, even if the display size of the LCD 500 increases, the frames displayed thereon still have high quality.

In the fabrication process of the LCD, since the first switch unit (for pixel) and the second switch unit (for switching gate driving signal) are fabricated in the same process, the overall cost of the LCD does not increase. Compared to the LCD of the present invention, the conventional LCD has to add gate driving circuits as the number of the columns of the pixels increases, which increases the overall cost as well.

To sum up, the gate driving module of the present invention effectively utilizes the switch units for switching gate driving signals to the corresponding pixels so as to save the expense of the additional gate driving circuits, providing convenience to users.

Those skilled in the art will readily observe that numerous modifications and alterations of the device and method may be made while retaining the teachings of the invention.

What is claimed is:

1. A gate driving module, for driving a display device having a plurality of first switch units, the gate driving module comprising:
a gate driving circuit, comprising a plurality of first output ends, for outputting a plurality of gate driving signals;
a switch controlling circuit, comprising a plurality of second output ends, for outputting a plurality of switch controlling signals; and
a plurality of switch sets, each of the plurality of the switch sets comprising at least two second switch units, one end of the each second switch unit coupled to a corresponding first output end of the plurality of the first output ends of the gate driving circuit, another end of the each second switch unit coupled to a control end of a corresponding first switch unit of the plurality of the first switch units of the display device, a control end of the each second switch unit coupled to a corresponding second output end of the plurality of the second output end of the switch controlling circuit;
wherein number of the first switch units of the display device is a multiple number of the first output ends of the gate driving circuit.

2. The gate driving module of claim 1, wherein the multiple is number of the second output ends of the switch controlling circuit.

3. The gate driving module of claim 1, wherein the number of the first switch units of the display device is higher than the number of the first output ends of the gate driving circuit.

4. The gate driving module of claim 1, wherein the second switch unit comprises a thin film transistor (TFT).

5. The gate driving module of claim 4, wherein the second switch unit further comprises a diode, and the negative end of the diode is coupled to a gate of the TFT.

6. An LCD, comprising:
a plurality of first switch units;
a gate driving module, comprising:
a gate driving circuit, comprising a plurality of first output ends, for outputting a plurality of gate driving signals;
a switch controlling circuit, comprising a plurality of second output ends, for outputting a plurality of switch controlling signals; and
a plurality of switch sets, each of the plurality of the switch sets comprising at least two second switch units, one end of the each second switch unit coupled to a corresponding first output end of the plurality of the first output ends of the gate driving circuit, another end of the each second switch unit coupled to a control end of a corresponding first switch unit of the plurality of the first switch units, a control end of the each second switch unit coupled to a corresponding second output end of the plurality of the second output ends of the switch controlling circuit; and
a data driving circuit, comprising a plurality of third output ends, each third output end coupled to an input end of a corresponding first switch unit of the plurality of the first switch units, for transmitting corresponding data;
wherein number of the first switch units of the display device is a multiple number of the first output ends of the gate driving circuit.

7. The LCD of claim 6, wherein the multiple is number of the second output ends of the switch controlling circuit.

8. The LCD of claim 6, wherein the number of the first switch units of the display device is higher than the number of the first output ends of the gate driving circuit.

9. The LCD of claim 6, wherein the second switch unit comprises a thin film transistor (TFT).

10. The LCD of claim 9, wherein the second switch unit further comprises a diode, and the negative end of the diode is coupled to a gate of the TFT.
